(19) United States
(12) Patent Application Publication
(10) Pub. No.: US 2007/0182109 A1
(43) Pub. Date: Aug. 9, 2007

(54) QUICK CONNECT/DISCONNECT CHUCKS

(76) Inventors: Cecily Considine, Waleska, GA (US); Michael Affatato, Waleska, GA (US)

Correspondence Address: GARDNER GROFF SANTOS & GREENWALD, P.C., 2018 POWERS FERRY ROAD, SUITE 800, ATLANTA, GA, 30339, US

(21) Appl. No.: 11/531,357

(22) Filed: Sep. 13, 2006

Related U.S. Application Data
(60) Provisional application No. 60/716,872, filed on Sep. 14, 2005.

(51) Int. Cl. B23B 31/28

(52) U.S. Cl. 279/128

(57) ABSTRACT

Described herein are a quick connect/disconnect chucks for use with a milling machine or lathe for holding a tool or work piece.

### IN THE CROSS-REFERENCE TO RELATED APPLICATIONS

This application claims priority to U.S. Provisional Application Ser. No. 60/716,872, filed Sep. 14, 2005, which is hereby incorporated herein by reference in its entirety for all purposes.

### TECHNICAL FIELD

The present invention relates to quick connect/disconnect chucks for use with a milling machine or lathe.

### BACKGROUND OF THE INVENTION

Milling machines and lathes such as, for example, jewelry making machines, generally possess a cutting tool mounted to a drive motor to make precision cuts on the piece of jewelry. The piece of jewelry is placed underneath the cutting tool, and with the use of computer numerical control (CNC), a desired design can be cut on the surface of the jewelry. Typically, the jewelry is mounted to a rotating chuck. Although the chuck may be adapted to receive different types of jewelry, the current chucks are not practical for the rapid mounting of different types of jewelry on the chuck. Thus, what is required is a receiver that can be mounted on a chuck that can readily accept a holding tool or a work piece (e.g., a piece of jewelry). The receiver should securely hold the work piece or tool yet readily release the work piece or tool when needed. The quick connect/disconnect chucks described herein address this need.

### SUMMARY OF THE INVENTION

Generally described, provided herein are quick connect/disconnect chucks for use with a milling machine or lathe for holding a tool or work piece.

In one aspect, described herein is a quick connect/disconnect chuck for use with a milling machine or lathe for holding a tool or work piece, the chuck comprising:

a receiver portion having a tapered opening;

a tool holder adapted to be removably mounted in the receiver portion, the tool holder having a tapered shank to be received in the tapered opening of the receiver portion; and

a detent mechanism for releasably holding the tool holder in the receiver portion.

In another aspect, described herein is a quick connect/disconnect chuck for use with a milling machine or lathe for holding a tool or work piece, the chuck comprising:

a receiver portion having a tapered opening and an interior surface;

a tool holder adapted to be removably mounted in the receiver portion, the tool holder having a tapered shank to be received in the tapered opening of the receiver portion; and

at least one magnet mounted to the interior surface of the receiver portion, wherein the magnet releasably holds the tool holder in the receiver portion.

In a further aspect, described herein is a quick connect/disconnect chuck for use with a milling machine or lathe for holding a tool or work piece, the chuck comprising:

a receiver portion having a tapered opening;

a tool holder adapted to be removably mounted in the receiver portion, the tool holder having a tapered shank with an exterior surface to be received in the tapered opening of the receiver portion; and

at least one magnet mounted to the exterior surface of the tapered shank, wherein the magnet releasably holds the tool holder in the receiver portion.

The specific techniques and structures employed by the invention to improve over the drawbacks of the prior devices and accomplish the advantages described herein will become apparent from the following detailed description of the example embodiments of the invention and the appended drawings and claims.

### BRIEF DESCRIPTION OF THE DRAWINGS

FIG. 1 is a front view of a jewelry making machine known in the art.

FIG. 2 is a side view of a chuck with a detent mechanism described herein.

FIG. 3 is a side view of a tool holder that can be secured to a quick connect/disconnect chuck having a detent mechanism.

FIG. 4 is a side view of a chuck described herein with magnetic strips mounted on the interior surface of the chuck for receiving a tool holder.

FIG. 5 is a side view of a tool holder described herein with magnetic strips mounted on the exterior surface of the tapered shank for insertion into the chuck.

FIG. 6 is a front view of a jewelry making machine known in the art with a chuck described herein mounted to the rotary chuck.

### DETAILED DESCRIPTION OF EXAMPLE EMBODIMENTS

The present invention may be understood more readily by reference to the following detailed description of the invention taken in connection with the accompanying drawing figures, which form a part of this disclosure. It is to be understood that this invention is not limited to the specific devices, methods, conditions, or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

Generally described, provided herein are quick connect/disconnect chucks. The chucks provide the quick insertion and removal of a tool holder. The tool holder can hold any tool used in milling machines or lathes. The tool holder can also hold a work piece to be milled. For example, the work piece can be a piece of jewelry or a jewelry precursor such as, for example, a wax substrate used as a mold to produce jewelry. Although the chucks described herein easily release the tool holder, the tool holder is held firmly by the chuck and, thus, ensures high concentricity when the chuck is rotated about an axis. This is desirable particularly in the jewelry making business for producing precise and reproducible cuts on the piece of jewelry or jewelry precursor.

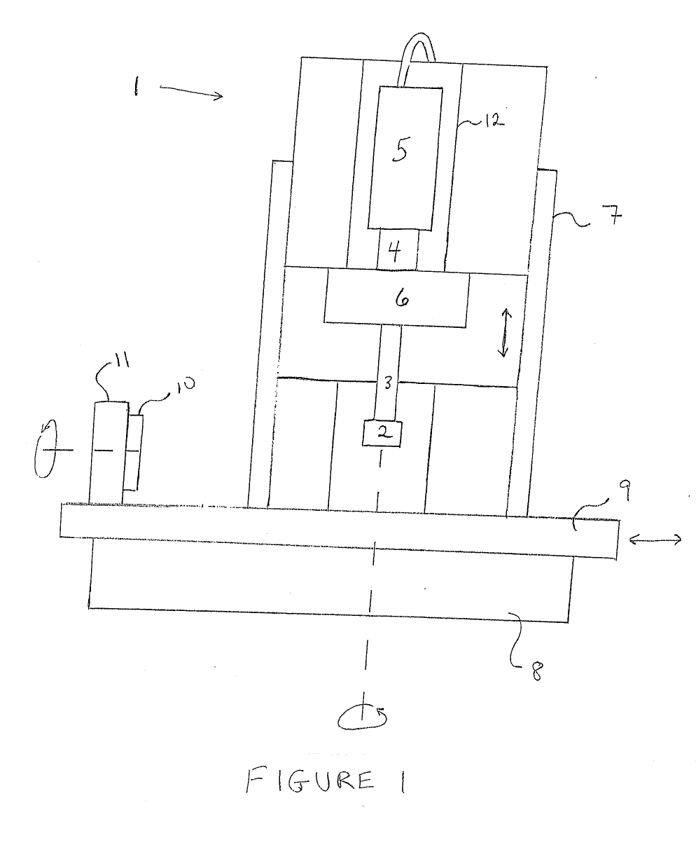

Referring now to the drawings, wherein reference numerals represent like parts throughout, FIG. 1 shows the front view of a typical jewelry making machine (1) known in the art. Referring to FIG. 1, a chuck 2 is mounted to a spindle shaft 3, where the chuck 2 typically holds a cutting tool such as, for example, a drill bit. Other tools known in the art besides a cutting tool can be inserted into the chuck 2 depending upon the desired application. The spindle shaft 3 is inserted in quill 4, which insures high concentricity when the spindle shaft 3 is spinning. A drive motor within motor casing 5 spins the spindle shaft 3 within the quill 4. The spindle shaft 3 and quill 4 are mounted to a sled 6. The sled 6 is mounted to a lift 12, where the sled 6 can be raised or lowered. The sled 6 can be raised or lowered, which can be controlled by a computer (not shown) using computer software known in the art (e.g., JewelSmith manufactured by Delcam). The lift 12 is mounted to frame 7. The bottom portion of the frame 7 is mounted to a base 8. Mounted to the base 8 is a movable plate or bed 9, which can move parallel and/or perpendicular to the frame 7. The position of the movable plate or bed 9 relative to the frame 7 can be controlled by a computer using the software described above. Mounted to the movable plate or bed 9 is a rotary chuck 10, which is mounted to the movable plate or bed 9 by a support 11. Other jewelry making machines having similar design specifications can be used herein, including those manufactured by Gem Vision, Model Master, Minitech Machinery Corp., Sherline Products Inc., Intellitech Inc., and MicroKinetics Corp.

A number of different fixtures known in the art can be attached to the rotary chuck 10. The jewelry or jewelry precursor to be cut using the device described herein can also be mounted on the rotary chuck 10. The rotary chuck 10 can be rotated clockwise or counter-clockwise via the support 11 by way of the computer. However, rotary chucks currently used in jewelry making machines do not permit the facile replacement of tools or working pieces. The replacement of tools or work pieces using prior art chucks is time-consuming. Moreover, alignment of the tool or work piece relative to the chuck is required, which adds further inefficiency.

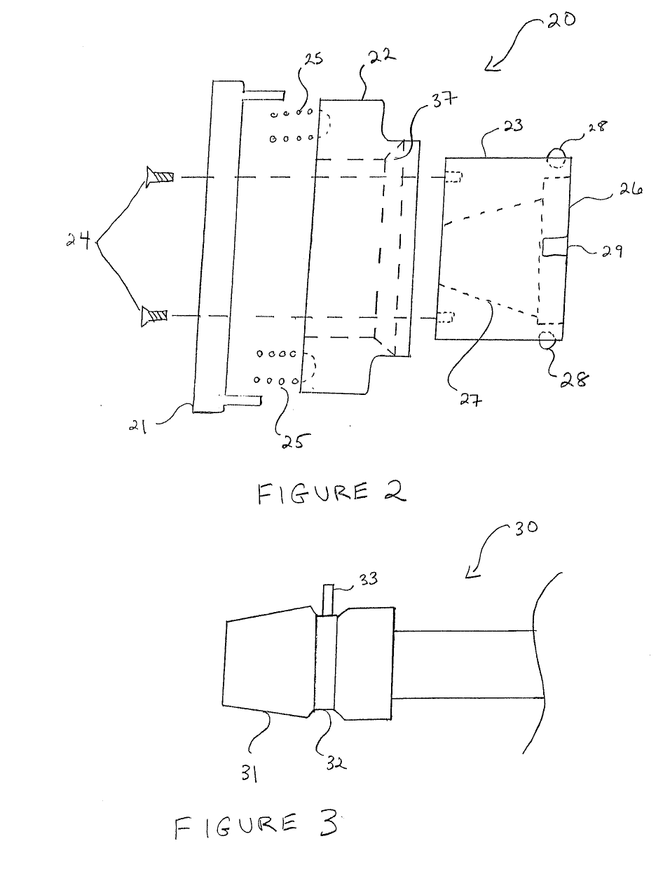

FIG. 2 shows an example of a quick connect/disconnect chuck of the invention. The body of the chuck 20 comprises three pieces connected to each other: the base 21, the cam 22, and the detent sleeve 23. The base 21 and the detent sleeve 23 are held together by one or more screws 24, with the cam 22 positioned outside the detent sleeve 23 . The base 21, the cam 22, and the detent sleeve 23 can be manufactured from the same or different materials such as, for example, iron, steel, aluminum, and the like. The base 21 and the cam 22 can also be manufactured in any desired shape for facilitating the release of the tool holder from the chuck 20.

Interposed between the base 21 and cam 22 are one or more springs 25. For example, a single spring that fits in the inner diameter of the cam 22 can be used. The spring 25 permits the cam 22 to be pushed toward the base 21 and away from detent balls 28. The detent mechanism is described in detail below.

Referring to FIGS. 2 and 3, the detent sleeve 23 has a receiving portion 26 to receive the tool holder 30. The tool holder 30 has a tapered shank 31, which fits in the tapered opening 27 in the detent sleeve 23. In this aspect, the tool holder 30 also has a groove 32 around the tool holder 30, which can engage one or more detent balls 28. In a further aspect, a drive key 33 is securely mounted to tool holder 30. When the drive key 33 is present, a slot 29 is present in the detent sleeve 23 for engaging and receiving the drive key 33. In this aspect, the drive key 33 prevents the tool holder 30 from rotating within the detent sleeve 23.

The chucks described herein permit the facile insertion/removal of a tool or work piece. In one aspect, the quick connect/disconnect chuck comprises detent mechanism. The detent mechanism comprises a movable cam for locking and unlocking the detent balls, wherein when the detent balls are unlocked, the tool holder can be removed from the detent sleeve. Referring to FIG. 2, the springs 25 permit the cam 22 to be pushed toward the base 21. When a tool holder 30 is locked in the detent sleeve 23, the tool holder 30 can be removed by sliding or pushing the cam 22 towards the base 21 and removing the tool holder 30. By sliding the cam 22 towards the base 21, the detent balls 28 disengage the tool holder 30. Conversely, when the cam 22 is not pushed back toward the base 21, the detent mechanism is in the locked position, and the cam 22 pushes the detent balls 28 into groove 32 of the tool holder 30, which secures the tool holder 30 in place in the detent sleeve 23. The interior of the cam 22 is tapered, which is depicted as 37 in FIG. 2. It is the taper 37 that locks the detent balls 28 into groove 32 of the tool holder 30. When the cam 22 is pushed toward the base 21, the taper 37 is also moved towards the base 21 as well, which then releases the detent balls 28 and permits the removal of the tool holder 30. The detent mechanism is also responsible for preventing the cam 22 from sliding forward and away from the base 21.

When inserting a tool holder 30 into the chuck 20, it is not necessary to slide the cam 22 toward the base 21. In one aspect, the tool holder 30 can be inserted into the receiver portion 26, wherein the tool holder 30 pushes the detent balls 28 aside enough to allow the tool holder 30 to be fully seated and then locked in place in the receiver portion 26. When the tool holder 30 is inserted in the detent sleeve 23, the cam 22 is pushed slightly toward the base 21.

In the case when drive key 33 is present on tool holder 30, the drive key 33 is aligned with slot 29 on detent sleeve 23 prior to insertion of the tool holder 30 into the receiving portion 26.

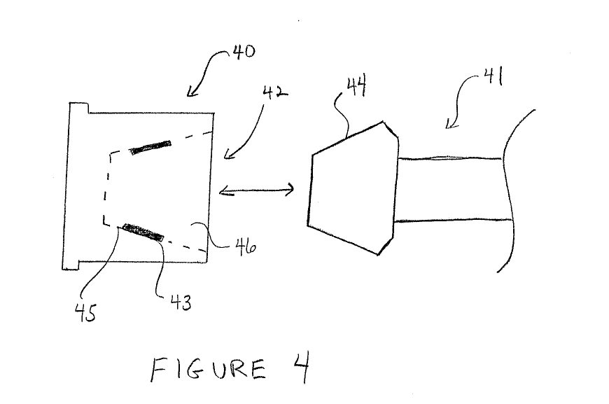

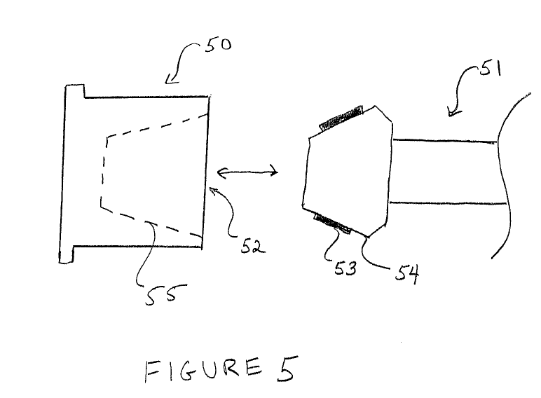

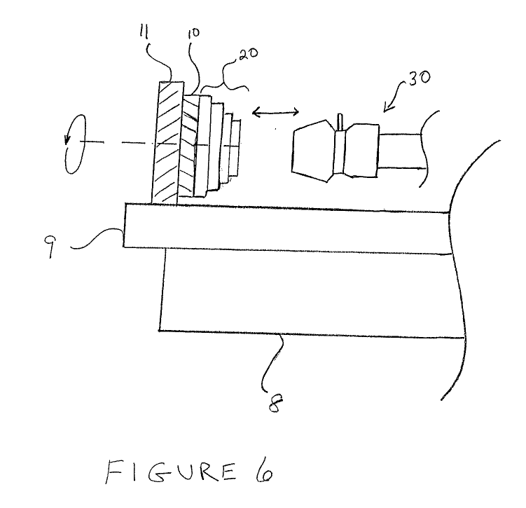

Another aspect of the quick connect/disconnect chucks described herein is shown in FIGS. 4 and 5. Referring to FIG. 4, the quick connect/disconnect chuck 40 has a receiver portion 42 with a tapered opening 46. The tapered opening 46 creates an interior surface 45 in the chuck 40. Mounted to the interior surface 45 of the chuck 40 is at least one magnet 43. In this aspect, the magnet 43 is a magnetic strip, but other magnets known in the art can be used as well. Thus, when the tool holder 41 is inserted into the receiver portion 42 of chuck 40, the tool holder 41 is securely attached to the chuck 40 by way of magnetic attraction between the magnet 43 and the tapered shank 44. In this aspect, the tapered shank 44 is made of a magnetic material such as, for example, iron. It is contemplated that the tool holder 41 can have a key drive mounted to the tool holder 41 to further ensure that tool holder does not rotate in chuck 40.

FIG. 5 shows another application of using magnetic strips to secure the tool holder to the chuck. In this aspect, one or more magnetic strips 53 are mounted to the tapered shank 54 of tool holder 51. When tool holder 51 is inserted into the receiver portion 52 of chuck 50, the tool holder 51 is securely attached to the interior surface 55 of the chuck 50. In this aspect, the interior surface 55 of the chuck 50 is composed of a magnetic material such as, for example, iron. Here, there is a magnetic attraction between the magnet 53 and the interior surface 55 of the chuck 50. Similar to above, it is contemplated that the tool holder 51 can have a key drive mounted to the tool holder 51 to further ensure that tool holder does not rotate in chuck 50.

The quick connect/disconnect chucks described herein can be mounted to a milling machine or lathe where tools and work pieces are generally attached or mounted. In one aspect, the quick connect/disconnect chucks described herein can be mounted to jewelry making machines. Referring to FIG. 6, the quick connect/disconnect chuck 20 is mounted to rotary chuck 10. The chuck 20 can be mounted to the rotary chuck 10 with screws, bolts, pins, clips, and the like. For example, the quick connect/disconnect chucks described herein can be mounted to a Sherline chuck, which is commonly used in jewelry making machines. With the chuck 20 securely mounted to rotary chuck 10, it is possible to quickly replace a number of different tools or work pieces, which increases the efficiency of the milling machine or lathe. Additionally, the quick connect/disconnect chucks described herein also ensure high concentricity when the tool or work piece is inserted into the chuck, which is another important feature particularly in the jewelry making industry.

It is to be understood that this invention is not limited to the specific devices, methods, conditions, or parameters described and/or shown herein, and that the terminology used herein is for the purpose of describing particular embodiments by way of example only. Thus, the terminology is intended to be broadly construed and is not intended to be limiting of the claimed invention. For example, as used in the specification including the appended claims, the singular forms “a,” “an,” and “the” include the plural, the term “or” means “and/or,” and reference to a particular numerical value includes at least that particular value, unless the context clearly dictates otherwise. In addition, any methods described herein are not intended to be limited to the sequence of steps described but can be carried out in other sequences, unless expressly stated otherwise herein.

While the invention has been described with reference to example and alternative embodiments, it will be understood by those skilled in the art that a variety of modifications, additions and deletions are within the scope of the invention, as defined by the following claims.

What is claimed is:

1. A quick connect/disconnect chuck for use with a milling machine or lathe for holding a tool or work piece, the chuck comprising:
a receiver portion having a tapered opening;
a tool holder adapted to be removably mounted in the receiver portion, the tool holder having a tapered shank to be received in the tapered opening of the receiver portion; and
a detent mechanism for releasably holding the tool holder in the receiver portion.

2. A chuck as claimed in claim 1 wherein the detent mechanism comprises one or more detent balls.

3. A chuck as claimed in claim 2 wherein the tool holder has a groove for engaging the detent balls therein.

4. A chuck as claimed in claim 1 wherein the tool holder, when received in the receiver portion, is prevented from rotating relative to the receiver portion by a drive key.

5. A chuck as claimed in claim 4 wherein the drive key is securely mounted to the tool holder and the receiver portion has a slot for engaging and receiving the drive key.

6. A chuck as claimed in claim 2 wherein the detent mechanism comprises a movable cam for locking and unlocking the detent balls, wherein with the detent balls unlocked the tool holder can be removed from the receiver portion.

7. A chuck as claimed in claim 6 wherein the movable cam is adapted and configured to allow insertion of the tool holder into the receiver portion, and wherein as the tool holder is inserted into the receiver portion the tool holder pushes the detent balls aside enough to allow the tool holder to be fully seated and then locked in place in the receiver portion.

8. A chuck as claimed in claim 6 wherein the movable cam comprises a sleeve-like element with an inner cam surface for engaging the one or more detent balls.

9. A chuck as claimed in claim 6 further comprising one or more springs for biasing the movable cam toward a locking position for selectively preventing removal of the tool holder from the receiver portion.

10. A quick connect/disconnect chuck for use with a milling machine or lathe for holding a tool or work piece, the chuck comprising:
a receiver portion having a tapered opening and an interior surface;
a tool holder adapted to be removably mounted in the receiver portion, the tool holder having a tapered shank to be received in the tapered opening of the receiver portion; and
at least one magnet mounted to the interior surface of the receiver portion, wherein the magnet releasably holds the tool holder in the receiver portion.

11. A chuck as claimed in claim 10, wherein the magnet comprises a magnetic strip.

12. A quick connect/disconnect chuck for use with a milling machine or lathe for holding a tool or work piece, the chuck comprising:
a receiver portion having a tapered opening;
a tool holder adapted to be removably mounted in the receiver portion, the tool holder having a tapered shank with an exterior surface to be received in the tapered opening of the receiver portion; and
at least one magnet mounted to the exterior surface of the tapered shank, wherein the magnet releasably holds the tool holder in the receiver portion.

13. A chuck as claimed in claim 12, wherein the magnet comprises a magnetic strip.
